(19) United States
(12) Patent Application Publication
(10) Pub. No.: US 2009/0102157 A1
(43) Pub. Date: Apr. 23, 2009

(54) Wheel Chair

(76) Inventor: David Sanchez Lopez, Zaragoza (ES)

Correspondence Address: POWER DEL VALLE LLP, 233 WEST 72 STREET, NEW YORK, NY, 10023, US

(21) Appl. No.: 12/299,874

(22) PCT Filed: May 9, 2007
(86) PCT No.: PCT/ES2007/000270

§ 371 Date: Nov. 6, 2008

(30) Foreign Application Priority Data
May 9, 2006 (ES) P20060128

(51) Int. Cl. B62M 1/14

(52) U.S. Cl. 280/250.1

(57) ABSTRACT

A frame (1) that is similar to that of a conventional wheelchair with footrest (2), pushing handles (3) and provided with a pair of rear driving wheels (4) and another pair of front guiding wheels (5), a wheelchair with armrests (6) that slide in a longitudinal front-back direction over guide rails (7), with each guide rail provided with a rack (9) that through a pair of pinions (10-10′) transmit movement to a transverse axle (11) to which an indented corona (15) is keyed, which through a transmission (16) allows a turning movement of the rear wheel (4) corresponding to the chair, through a set of pinions (18), so that with an alternating movement of the user's arms (13), acting over the armrests (6), a turning movement is created for the rear wheels (4) of the chair, allowing a noticeable improvement in the comfort of the user. The handle (19) associated with the armrest (6) facilitates said action, and the handle can also be used to activate the gear change established between the corona (15) and the pinions (18) as well as to act as a brake for the chair.

This invention pertains to a wheel chair, i.e. a chair that is used either on a temporary or a permanent basis by people who cannot walk and who therefore require a chair to move from one place to another.

The purpose of the invention is to provide a chair with a new means by which it can be moved by the user, significantly facilitating the process so that it is more comfortable and requires less physical effort.

### BACKGROUND OF THE INVENTION

As is well known, the classic wheelchair is basically built from a chair, that is with a back, a footrest, arm supports and a pair of handles in the back, that allow it to be pushed by a person other than the user. This structure rests on a pair of large diameter driving wheels in the rear and a pair of self-directional wheels of a considerably smaller diameter in the front.

To allow the chair to be moved by the user, the rear wheels are each provided with rings that can be used as grips so that the user moves the chair manually by moving the rings in intermittent pushing movements.

This conventional solution has barely evolved over time, remains in use today, and presents a series of problems, not the least of which include the discomfort associated with, and considerable effort required for, moving the chair.

This problem has been resolved in electric, or motorized chairs; however this solution also presents a series of problems due to the great weight as well as high cost of electric wheelchairs, and a functional dependence on the battery that feeds the motor, which must be periodically recharged and whose complete discharge can occur at the most unexpected and inopportune moments.

In order to eliminate this problem, the patent GB 2208432 describes and offers a mechanism designed to propel wheelchairs by the armrests which, acting in association with connecting rods and transmission mechanisms for its wheels, are manually activated in a basculating motion. Although this solution fulfills the function for which it was designed, it presents the problem that the body movements required of the user to make the basculating or angular movement necessary over the arm supports is extremely uncomfortable, requiring a continuous movement of the back with the consequent negative repercussions.

### BRIEF SUMMARY OF THE INVENTION

The wheelchair disclosed herein is one in which the user generates the force necessary to move the chair, resolving in a completely satisfactory way the problems described above and allowing a great ease of movement with minimum effort and in optimum comfort for the user.

The disclosed chair is constructed over the basic structure of a conventional, manually-activated chair, in which the chair has a pair of large diameter wheels in the rear which act as the driving wheels and a pair of considerably smaller diameter front wheels which act as the guide wheels. One of the essential characteristics of the present inventive chair is the fact that its arm supports slide in a side-rear direction over the respective guides; the arm supports are provided with the respective slides, so that they move in alternating longitudinal movements over a pair of pinions mounted over a common axle. In this way, one pinion acts in a determined direction of movement of the arm support and does not operate in the opposite direction, while the other pinion works inversely, thus using the forward as well as the reverse movement of each arm support to transmit a turning movement in the same direction over the axis over which the pinions are mounted. A corona is also used as a cleat, allowing the movement to at least one pinion established in the corresponding real and tractor wheel of the chair.

In this way, the arms move in a comfortable alternating movement which is transmitted to the mobile arm supports in a longitudinal sense and in a turning sense to the rear wheels of the chair, so that the back of the user can be perfectly supported by the back of the chair while making said movement, and the user is not required to use or move his back in order to move the chair.

Another characteristic of the invention is that more than one notched or indented corona can be established over said axle and more than one pinion over the wheel, so that with the collaboration of a conventional mechanism used to change gears, such as for example those used in determined bicycles, transmission of movement can be varied through a handle located over each of the mobile arm supports, with a wide range of possibilities available according to whether the chair is moving over a horizontal surface or any type of slope.

According to another of the characteristics of the invention this same handle is designed to act over a disc brake that is coupled to the axle of the rear driving wheels, in order to stop the chair as well as to control the direction of its movement.

### BRIEF DESCRIPTION OF THE DRAWINGS

To complement the description made and in order to help to better comprehend the characteristics of the invention, according to an example for a practical use of same, attached to this description and included as a part thereof is a set of drawings, provided simply for illustration and representing the following, among other things:

FIG. 1. A schematic representation with a front view showing a wheel chair of the present invention showing cross-sectional view of the arm supports, and more specifically at the level of the transmission axles.

FIG. 2. Another schematic representation of the first figure, now from a side view.

FIG. 3. An amplified detail of FIG. 2 of one of the arm supports.

FIG. 4. Finally, a transverse view of the detail of the above figure.

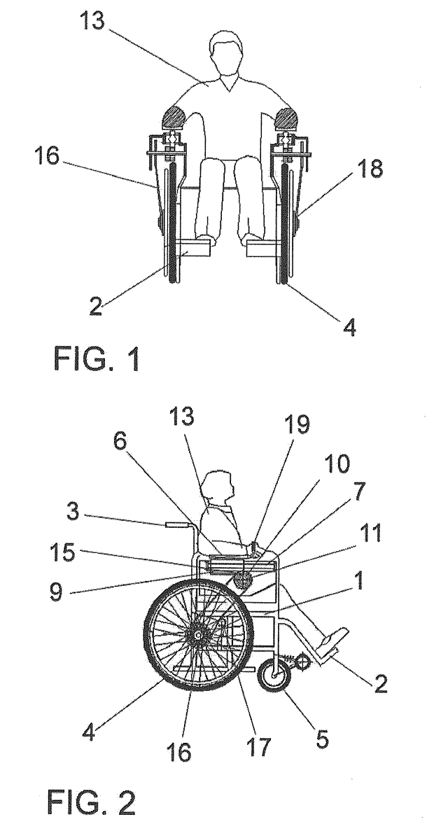

### DETAILED DESCRIPTION OF THE INVENTION

From the figures provided one can see how the wheelchair proposed in the invention is constituted from a conventional chair of this type, with a frame (1) that defines the chair itself, with a lower-front foot rest (2) and the classic rear handles (3) allowing it to be pushed by a third party; said structure (1) rests on a pair of rear driving wheels (4) with a large diameter, and a pair of front wheels (5) with a considerably smaller diameter which are self-guiding, which act as means of directing the chair as it moves.

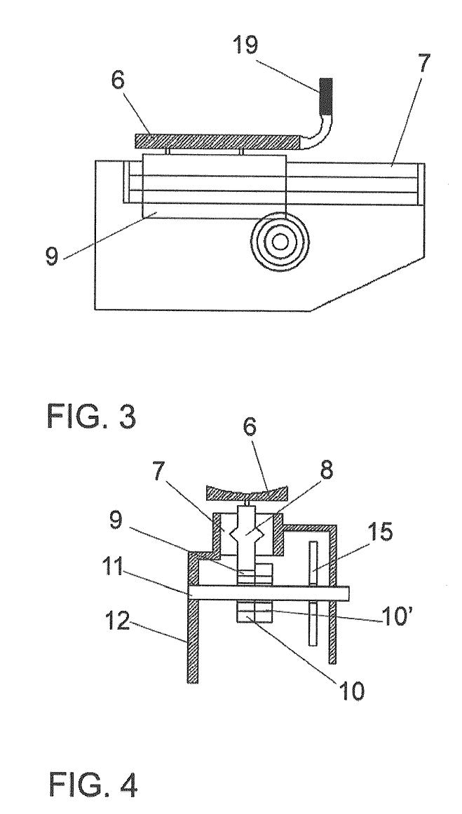

From this conventional basic structure, the proposed chair incorporates, at the top of the structure (1), lateral arm supports (6), adequately cushioned to provide due comfort, which present the unique quality of being moveable, specifically moving in a front-back direction over the respective guides (7) as can be specially seen in FIGS. 3 and 4. For this effect each arm support (6) is joined to a support (8) which is coupled by tongue and groove to the corresponding guide (7), with a rack (9) incorporated in the inferior edge of said support (8), moveable in a longitudinal direction and in conjunction with the arm support (6).

The rack (9) engages with a pinion (10) which is mounted over a transverse axle (11), which in turn in mounted with free turn over a housing (12) that covers all of these mechanisms, except for the arm supports (6). The pinion (10) is a kind that can be coupled to the axle (11) in a way that causes the axle to turn when the pinion is turned in a determined direction, and is thus free to turn without drag, in a contrary direction.

Over the axle (11) and fixed to the pinion (10) is a second pinion (10′) with a contrary movement; that is, it drags against the axle (11) when the rack (9) moves in the opposite direction to the direction in which it moves when drag is produced through the pinion (10), so that both the forward movement of the arm supports (6) as well as the backward movement of same, caused by the user (13), causes the axle (11) to turn, but always in the same direction.

As a complement to the structure described at least one indented corona (15) is also keyed to the axle (11), allowing various coronas of different diameters, so that said corona (15) transmits the movement to wheel (4) of the chair through a chain (16) with tensioner (17), and with a set of pinions (18) of different diameters so that with the collaboration of the tensioner and using a handle (19) associated to the arm support (6) the gears can be changed, similar to that of a bicycle, using the corona (15) and the pinion (18) that is most appropriate to each case.

This transmission system can be substituted by a system of belts and pulleys.

Handle (19) also acts as means of activating a disc brake on each of the rear wheels (4).

According to this structure the user (13) moves the chair with his hands; however, instead of doing so by directly turning the rear wheels (4) of the chair, this is done by applying a longitudinal forward and back movement of the handles (19); that is, by using the arms in a movement that is much more comfortable as well as much more effective, thus regulating at will the transmission to said wheels and simultaneously acting on the direction of the chair, and doing so while the user's back remains perfectly supported at all times by the chair back with no need to flex or bend while moving the arm supports.

The chair can also include a battery that uses, for example the energy generated when the chair moves over a descending slope, using this energy to facilitate the movement of the chair when passing over surface with adverse conditions.

1. Wheel chair, of the type constituted by a frame with lower front foot rest and handles behind to allow manual pushing by another person, as well as a pair of large diameter wheels in the rear which act as driving wheels, and another pair of smaller diameter wheels in front which act as guide wheels, comprising:
a first lateral armrest and a second lateral armrests over the frame which are mobile, and can be moved in a longitudinal direction over at least a first and a second guide, each of which guides is provided with a lower rack which, through the longitudinal movement of the guides and a set of primary pinions transmit movement to a transverse axle provided with a corona which through a chain supplies movement to at least one secondary pinion mounted over the axle of one of the rear wheels, so that the alternating front and back movement of each armrest determines a turning movement in the same direction for each of the rear wheels.

2. Wheelchair, according to claim 1, wherein the first and second lateral armrests are each attached to a first and second support which can be moved over the first guide and second guide, respectively, with the respective rack incorporated in the bottom edge of a first and second support so that each rack engages with one set of the primary pinions, one primary pinion having a drag with the axle and one having a drag contrary to the axle, so that while one of the primary pinions drags the axle in the same direction of movement as the armrests, the other primary pinions turns with respect to the axle.

3. Wheelchair, according to claim 2, wherein the axle having two ends is mounted transversally on a housing where each end extends through the housing and through the center of each rear wheel, and further comprising a plurality of indented coronas, a first and second set of secondary pinions mounted over each end of the axle extending through the rear wheels, such that each set of secondary pinions, in collaboration with a tensioner and a first handle and a second handle mounted on the first and second armrests respectively, can change gears to move the wheels.

4. Wheelchair, according to claim 3, wherein the handles can be used as a grip for providing longitudinal and alternating movements of the arm rests and which act as a disc brake established on the rear wheels
